(19) United States
(12) Patent Application Publication
(10) Pub. No.: US 2018/0210101 A1
(43) Pub. Date: Jul. 26, 2018

(54) SYSTEM AND METHOD FOR SEISMIC INVERSION

(71) Applicants: China Petroleum & Chemical Corporation, Beijing (CN); Sinopec Tech Houston, LLC., Houston, TX (US)

(72) Inventor: Stig HESTHOLM, Houston, TX (US)

(21) Appl. No.: 15/858,707

(22) Filed: Dec. 29, 2017

Related U.S. Application Data
(60) Provisional application No. 62/440,879, filed on Dec. 30, 2016.

(51) Int. Cl. G01V 1/28; G06F 17/50; G01V 1/24

(52) U.S. Cl. CPC G01V 1/282; G06F 2217/68; G01V 1/24; G06F 17/5009

(57) ABSTRACT

A method for elastic wave modeling up to tilted orthorhombic symmetry in anisotropy involves applying a curved grid adapting to a free-surface topography and transforming this the curved grid to a rectangular grid. Calculations using numerical discretization methods such as finite-difference are performed. The boundary condition for any free-surface is σᵢⱼ·nⱼ=0, which requires vanishing the global stresses' normal components to the free-surface. This resulting model more accurately simulates surface effects and better inversion for subsurface earth properties.

### CROSS-REFERENCE TO RELATED APPLICATION

This application claims priority to U.S. Provisional Patent Application having Ser. No. 62/440,879, filed Dec. 30, 2016 and is incorporated herein by reference in its entirety.

### FIELD OF TECHNOLOGY

The present disclosure relates generally to methods and devices for inverting seismic data to compute physical properties of the earth's subsurface, and in particular methods and systems for modeling free-surface waves to yield detailed subsurface features.

### BACKGROUND

Seismic inversion methods are used to image the subsurface of the earth for various purposes, including engineering problems, archeology, as well as oil & gas exploration. Input to inversion/imaging methods are seismic reflections from buried targets or reflectors of interest. When such reflected signals are monitored during land seismic processing, they are frequently blurred or hidden by prominent near-surface signals, such as surface waves, particularly the Rayleigh (Rg) waves. Such prominent near-surface signals camouflage reflections from targets and render the inversion less accurate.

Effects from the near-surface and in particular, the free-surface topography, has a pronounced effect on the wavefield in regard to strong amplitudes and scattering. Although topography represents some of the best known information available in seismic processing, near-surface signals have traditionally been minimized using processing methods such as muting, static corrections (in case of free-surface topography) and automatic gain correction, which render the inversion less accurate and computationally expensive. Accordingly, there is a need for a new seismic inversion method that takes into account near-surface seismic signals.

### SUMMARY OF INVENTION

The present disclosure provides methods and systems that treat surface waves as a part of the total wavefield in preprocessing of input signals for seismic inversion. In one of the embodiments of the method, boundary conditions are imposed in a curved grid and then implemented into a corresponding rectangular grid, where the numerical methods can be employed to discretize seismic data. Suitable numerical discretization methods include the Finite-Difference (FDs) methods as well as the Finite-Element (FE) methods, e.g., the Spectral Element (SE) methods.

In a specific embodiment, before the transform to the computational, rectangular grid, the boundary conditions and wave equations that are valid in an elastic medium are incurred in a curved grid. The properties of this curved grid is such that its top surface coincides with the free-surface topography to be simulated.

In a further embodiment, the curved grid generation is carried out implicitly by the transform of all equations from their curved grid to their rectangular grid counterpart through the use of the chain rule. The curved grid bottom is plane, and the grid's curvature increases with distance from the bottom—or alternatively decreases with distance from the top free-surface topography, where the curvature is at its maximum. Along the free-surface of the curved grid, vanishing stress along the local surface normal is enforced, leading to free-surface topography boundary conditions in terms of the particle velocities.

Methods in this disclosure represent a natural, automatic procedure for adapting a curved grid to any free-surface topography and still employ fast and accurate discretization methods like FD through employment of all equations' transform from the curved to a rectangular numerical grid. The transform of equations from curved to rectangular grid in such a way can be performed for both the elastic interior medium equations and for the free-surface topography boundary conditions. The elastic interior medium equations as well as the free-surface topography boundary conditions can possess anisotropy up to and including tilted orthorhombic symmetry.

### DESCRIPTIONS OF DRAWINGS

FIG. 1 is a flow chart illustrating a method of the current disclosure.

FIG. 2 illustrates in 2-D the 3-D transform from the curved grid (x, y, z) to the rectangular computational grid (ξ, κ, η).

FIGS. 3A-3F are seismic snapshots of the Vx (three images in the top row) and Vz (three images in the bottom row) tangential and normal component particle velocities for a Ricker explosion source released at the middle of a tilted, plane free-surface, covering a homogeneous, isotropic medium.

FIGS. 4A-4F are pressure snapshots along a vertical plane of a Ricker point source released at the focus of a parabola.

FIG. 5A and FIG. 5B are pressure snapshots using acoustic parameters in elastic tilted orthorhombic modeling, in which Ricker point source is released at depth of a homogeneous, acoustic tilted orthorhombic medium. For the purpose of comparison, FIG. 5C presents simulation results in a previously published article when a pure acoustic program code is employed.

FIGS. 6A-6G compare Vx horizontal particle velocity snapshots along a vertical xz-plane of the SEAM isotropic topography model for with FIGS. 6H-6N, which are Vx horizontal particle velocity snapshots for a homogeneous model covered by the same topography. The same vertical Klauder wavelet is released at the surface of the model in each case.

FIGS. 7A, 7B, and 7C are pressure seismograms generated using the heterogeneous SEAM isotropic topography model and respectively show the cross section of the middle, the left, and the right cross section of the same topography shown in FIGS. 6A-6N.

FIGS. 8A-8D show representative corresponding seismograms from the simulation of FIGS. 6A-6N, with FIGS. 8A and 8C from the full (heterogeneous) SEAM topography model, and FIGS. 8B and 8D from the corresponding homogeneous model.

### DETAILED DESCRIPTION OF THE EMBODIMENT

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple computer processors, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the scope of the present disclosure.

The Figures (FIG.) and the following description relate to the embodiments of the present disclosure by way of illustration only. It should be noted that from the following discussion, alternative embodiments of the structures and methods disclosed herein will be readily recognized as viable alternatives that may be employed without departing from the principles of the claimed inventions.

Referring to the drawings, embodiments of the present disclosure will be described. Various embodiments can be implemented in numerous ways, including for example as a system (including a computer processing system), a method (including a computer implemented method), an apparatus, a non-transitory computer readable medium, a computer program product, a graphical user interface, a web portal, or a data structure tangibly fixed in a non-transitory computer readable memory. Several embodiments of the present invention are discussed below. The appended drawings illustrate only typical embodiments of the present disclosure and therefore are not to be considered limiting of its scope and breadth.

Reference will now be made in detail to several embodiments of the present disclosure(s), examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures and methods illustrated herein may be employed without departing from the principles of the disclosure described herein.

In a seismic acquisition, a shot is deployed at the source location, generating a wavefield that propagates from the source to the subsurface structure. The reflection from the subsurface structure propagates back to the surface and is detected by the receivers. The receivers convert the seismic signals to voltage signals. The voltage signals are then transmitted to a computer in a recording station (not shown) to be processed and converted into seismic data. The seismic data can be stored and transmitted for further processing.

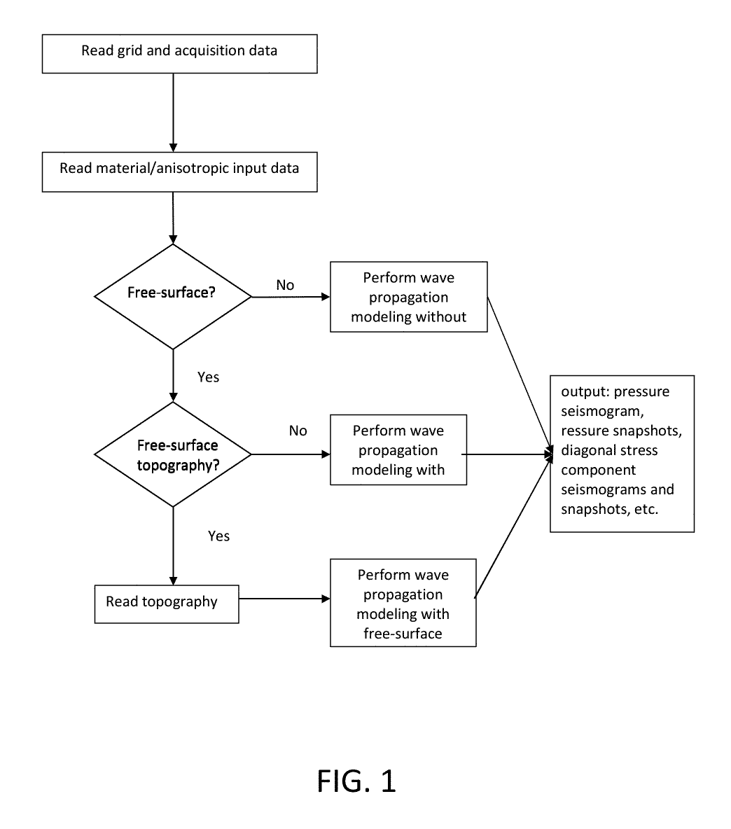

FIG. 1 shows a flow chart of the process of elastic seismic wave simulations with free-surface topography of the current disclosure. First, the parameters of the grid and the seismic acquisition data for seismic inversion are read and analyzed. Such parameters/data may include grid size (nx, ny, nz), directions (dx, dy, dz), cube dimensions (including the start and end values), shot location, run time, absorption layer thicknesses, absorption attenuation, receiver increments in x and y-directions, receiver depth, snapshot start, end and increment times, wanted output wave fields, wanted snapshot planes, etc.

Next, the data regarding the rock physics and other input data are obtained. Such data can be one or more among P-velocity (Vp), S-velocity (Vs), formation density (ρ), Thomsen epsilon parameters (ε₁, ε₂), Thomsen delta parameters (δ₁, δ₂, δ₃), gamma ratios (γ₁, γ₂), porosity (ϕ), the incident angle (θ), and the opening angle between the symmetry axes in the rotated xy-plane (β).

After loading all necessary material parameters, a decision is made whether a free-surface or an absorbing surface should be simulated at the top of the model. If a free-surface is confirmed, then a choice is made whether a surface topography is chosen at the free-surface. If the free-surface is chosen as the surface topography, its data is read and modeled as the top boundary of the medium; if not, a free plane surface is applied. The standard output of any simulation is seismic pressure seismograms, with optional output of seismic pressure snapshots, or seismograms or snapshots of stress components. Alternatives not listed in the flow chart are snapshots and seismograms of particle velocities.

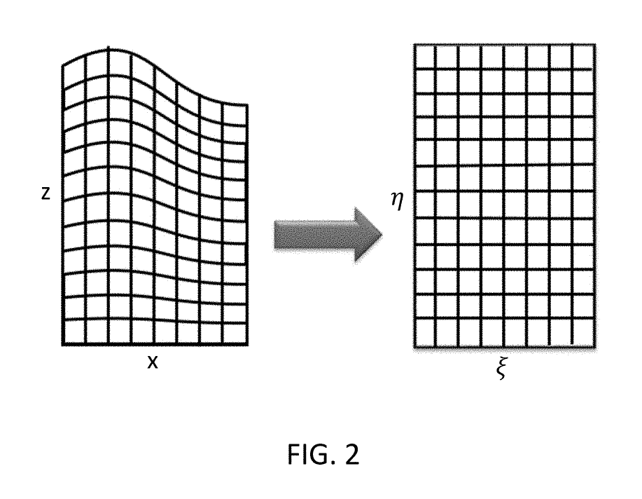

FIG. 2 is a 2D illustration of the 3D transform from the curved grid (x, y, z) (presented in its xz-plane) to the rectangular grid (ξ, κ, η) (presented in its ξη-plane). The numerical discretizations are performed in the rectangular grid. The top of the curved grid coincides with a free-surface topography being modeled. The bottom of the curved grid is planar. The undulations in the vertical direction reduce with depth towards the bottom. The wave equations and boundary conditions are originally imposed in this physically conformed curved grid.

When modeling a free-surface topography, it is assumed that elastic wave equations are given in a curved 3D grid. The mapping function from the curved (x, y, z) to the rectangular (ξ, κ, η) system is assumed to have positive downward direction, and it can be written as (Puente et al., 2014)

$$z ( ξ , κ , η ) = \frac{η}{{η}_{max}} ( {z}_{0} ( ξ , κ ) + m ) - {z}_{0} ( ξ , κ ) , \qquad ( 1 )$$

where ηₘₐₓ is the maximum value (the depth) of the rectangular grid; z₀ (ξ,κ) is the elevation (topography) function, which is positive upwards—the opposite of the vertical coordinates z and η. m is the maximum depth of the physical model (the curved grid z(ξ,κ,η)). The chain rule is apply to express the spatial derivatives in the curved (x,y,z) grid by the ones in the rectangular (ξ,κ,η) grid, which gives

$$\frac{\partial }{\partial x} \to \frac{\partial }{\partial ξ} \frac{\partial ξ}{\partial x} + \frac{\partial }{\partial η} \frac{\partial η}{\partial x} = \frac{\partial }{\partial ξ} + A ( ξ , κ , η ) \frac{\partial }{\partial η} ; \\ A ( ξ , κ , η ) = \frac{\partial η}{\partial x} = \frac{{η}_{max} - η}{{z}_{0} ( ξ , κ ) + m} {h}_{x} , \\ \frac{\partial }{\partial y} \to \frac{\partial }{\partial κ} \frac{\partial κ}{\partial y} + \frac{\partial }{\partial η} \frac{\partial η}{\partial y} = \frac{\partial }{\partial κ} + B ( ξ , κ , η ) \frac{\partial }{\partial η} ; \\ B ( ξ , κ , η ) = \frac{\partial η}{\partial y} = \frac{{η}_{max} - η}{{z}_{0} ( ξ , κ ) + m} {h}_{y} , \\ \frac{\partial }{\partial z} \to \frac{\partial }{\partial η} \frac{\partial η}{\partial z} = C ( ξ , κ ) \frac{\partial }{\partial η} ; C ( ξ , κ ) = \frac{\partial η}{\partial z} = \frac{{η}_{max}}{{z}_{0} ( ξ , κ ) + m} , \qquad ( 2 )$$

where

$${h}_{x} = \frac{\partial {z}_{0} ( ξ , κ )}{\partial ξ}$$

is the topograpny slope in the x (or ξ) direction and

$${h}_{y} = \frac{\partial {z}_{0} ( ξ , κ )}{\partial κ}$$

is the topography slope in the y (or κ) direction. Details of derivation of the coordinate partial derivatives A(ξ,κ,η),B(ξ,κ,η) and C(ξ,κ) can be found in Hestholm and Ruud (1998).

Let σ′ and ν′ with components σᵢⱼ′ and νᵢ′, i,j=1 . . . 3, be stresses and particle velocities in a vertical orthorhombic medium. Let σ and ν, with components σᵢⱼ and νᵢ, be the stresses and particle velocities directed along the coordinates of the symmetry axes of a tilted orthorhombic medium. The rotation of velocities from vertical to tilted orthorhombic system can then be written ν=Rν′, and the rotation of stresses from vertical to tilted orthorhombic system can be written σ=Mσ′, where M is the Bond matrix, consisting of products and sums of the components Rᵢⱼ of rotation matrix R. The rotation matrix is given by

$$R = ( \begin{matrix}cos φ cos θ cos β - sin φ sin β & - cos φ cos θ sin β - sin φ cos β & cos φ sin θ \\ sin φ cos θ cos β + cos φ sin β & - sin φ cos θ sin β + cos φ cos β & sin φ sin θ \\ - sin θ cos β & sin θ sin β & cos θ\end{matrix} ) , \qquad ( 3 )$$

where ϕ, θ, and β, respectively, are the angles of azimuth, tilt, and opening angle between the symmetry axes in the rotated xy-plane.

In an embodiment of the current disclosure, when simulating a tilted orthorhombic system, the stress-strain relationship (Hooke's law) is given by

σ=Cε, (4)

with C being the full 6×6 stiffness matrix in the rotated system, which is given in terms of the Bond matrix M as

C=MC′M^{T}. (5)

σ and ε are stress and strain in the tilted orthorhombic system, and C′ is the stiffness matrix in the vertical orthorhombic system. C, being a full matrix, increases the amount of computations and/or storage from those of a vertical orthorhombic system. Furthermore, when the curved grid is introduced and transformed to the rectangular grid according to transform (2), the stress-strain relation described by equation (4) will have time derivatives of strain components εᵢ, i=1 . . . 6, given by

$$\begin{matrix}\frac{\partial {ɛ}_{1}}{\partial t} = \frac{\partial {v}_{x}}{\partial ξ} + A \frac{\partial {v}_{x}}{\partial η} , & ( 6 ) \\ \frac{\partial {ɛ}_{2}}{\partial t} = \frac{\partial {v}_{y}}{\partial κ} + B \frac{\partial {v}_{y}}{\partial η} , & ( 7 ) \\ \frac{\partial {ɛ}_{3}}{\partial t} = C \frac{\partial {v}_{z}}{\partial η} , & ( 8 ) \\ \frac{\partial {ɛ}_{4}}{\partial t} = C \frac{\partial {v}_{y}}{\partial η} + \frac{\partial {v}_{z}}{\partial κ} + B \frac{\partial {v}_{z}}{\partial η} , & ( 9 ) \\ \frac{\partial {ɛ}_{5}}{\partial t} = C \frac{\partial {v}_{x}}{\partial η} + \frac{\partial {v}_{z}}{\partial ξ} + A \frac{\partial {v}_{z}}{\partial η} , & ( 10 ) \\ \frac{\partial {ɛ}_{6}}{\partial t} = \frac{\partial {v}_{x}}{\partial κ} + B \frac{\partial {v}_{x}}{\partial η} + \frac{\partial {v}_{y}}{\partial ξ} + A \frac{\partial {v}_{y}}{\partial η} . & ( 11 )\end{matrix}$$

Similarly, Newton's 2^{nd} law (the momentum conservation equations) in a curved coordinate system,

$$\begin{matrix}\frac{\partial {v}_{x}}{\partial t} = \frac{1}{ρ} ( \frac{\partial {σ}_{xx}}{\partial x} + \frac{\partial {σ}_{xy}}{\partial y} + \frac{\partial {σ}_{xz}}{\partial z} ) , & ( 12 ) \\ \frac{\partial {v}_{y}}{\partial t} = \frac{1}{ρ} ( \frac{\partial {σ}_{xy}}{\partial x} + \frac{\partial {σ}_{yy}}{\partial y} + \frac{\partial {σ}_{yz}}{\partial z} ) , & ( 13 ) \\ \frac{\partial {v}_{z}}{\partial t} = \frac{1}{ρ} ( \frac{\partial {σ}_{xz}}{\partial x} + \frac{\partial {σ}_{yz}}{\partial y} + \frac{\partial {σ}_{zz}}{\partial z} ) , & ( 14 )\end{matrix}$$

when transformed to the rectangular (ξ,κ,η)-system through coordinate transform (2) becomes

$$\begin{matrix}\frac{\partial {v}_{x}}{\partial t} = \frac{1}{ρ} ( \frac{\partial {σ}_{xx}}{\partial ξ} + A \frac{\partial {σ}_{xx}}{\partial η} + \frac{\partial {σ}_{xy}}{\partial κ} + B \frac{\partial {σ}_{xy}}{\partial η} + C \frac{\partial {σ}_{xz}}{\partial η} ) , & ( 15 ) \\ \frac{\partial {v}_{y}}{\partial t} = \frac{1}{ρ} ( \frac{\partial {σ}_{xy}}{\partial ξ} + A \frac{\partial {σ}_{xy}}{\partial η} + \frac{\partial {σ}_{yy}}{\partial κ} + B \frac{\partial {σ}_{yy}}{\partial η} + C \frac{\partial {σ}_{yy}}{\partial η} ) , & ( 16 ) \\ \frac{\partial {v}_{z}}{\partial t} = \frac{1}{ρ} ( \frac{\partial {σ}_{xz}}{\partial ξ} + A \frac{\partial {σ}_{xz}}{\partial η} + \frac{\partial {σ}_{yz}}{\partial κ} + B \frac{\partial {σ}_{yz}}{\partial η} + C \frac{\partial {σ}_{zz}}{\partial η} ) . & ( 17 )\end{matrix}$$

At the free-surface, the rectangular grid vertical coordinate η=0, so the equations (18) can be derived from equations (2)

$$A ( ξ , κ , η ) = \frac{{η}_{max}}{{z}_{0} ( ξ , κ ) + m} {h}_{x} = C ( ξ , κ ) {h}_{x} , \\ B ( ξ , κ , η ) = \frac{{η}_{max}}{{z}_{0} ( ξ , κ ) + m} {h}_{y} = C ( ξ , κ ) {h}_{y} , \\ C ( ξ , κ ) = \frac{{η}_{max}}{{z}_{0} ( ξ , κ ) + m} . \qquad ( 18 )$$

In the embodiment of the current disclosure, the boundary condition for any free-surface is vanishing normal traction, σᵢⱼ·nⱼ=0, where σᵢⱼ are the stress tensor components, and nⱼ are the components of the inward directed (unit) normal vector n=(hₓ, h_{y}, 1) to the surface, with hₓ and h_{y} the topography slopes as before. Component-wise this becomes, after differentiating with respect to time,

$${h}_{x} \frac{\partial {σ}_{xx}^{′}}{\partial t} + {h}_{y} \frac{\partial {σ}_{xy}^{′}}{\partial t} + \frac{\partial {σ}_{xz}^{′}}{\partial t} = 0 , \\ {h}_{x} \frac{\partial {σ}_{xy}^{′}}{\partial t} + {h}_{y} \frac{\partial {σ}_{yy}^{′}}{\partial t} + \frac{\partial {σ}_{yz}^{′}}{\partial t} = 0 , \\ {h}_{x} \frac{\partial {σ}_{xz}^{′}}{\partial t} + {h}_{y} \frac{\partial {σ}_{yz}^{′}}{\partial t} + \frac{\partial {σ}_{zz}^{′}}{\partial t} = 0. \qquad ( 19 )$$

Hooke's law, equation (4), is differentiated with respect to time, and the time differentiated stresses from it are inserted into boundary conditions (19). Moving all vertical derivatives of the particle velocities to the left hand sides of the equations, leads to the following boundary conditions in terms of the velocities νᵢ in the tilted orthorhombic system,

$$\begin{matrix}\frac{\partial {v}_{x}}{\partial η} [ {h}_{x}^{2} {Cc}_{11} + {h}_{y}^{2} {Cc}_{66} + {h}_{x} {h}_{y} C ( {c}_{16} + {c}_{61} ) + {h}_{x} C ( {c}_{15} + {c}_{51} ) + {h}_{y} C ( {c}_{56} + {c}_{65} ) + {Cc}_{55} ] + \frac{\partial {v}_{y}}{\partial η} [ {h}_{x}^{2} {Cc}_{16} + {h}_{y}^{2} {Cc}_{62} + {h}_{x} {h}_{y} C ( {c}_{12} + {c}_{66} ) + {h}_{x} C ( {c}_{14} + {c}_{56} ) + {h}_{y} C ( {c}_{64} + {c}_{52} ) + {Cc}_{54} ] + \frac{\partial {v}_{z}}{\partial η} [ {h}_{x}^{2} {Cc}_{15} + {h}_{y}^{2} {Cc}_{64} + {h}_{x} {h}_{y} C ( {c}_{14} + {c}_{65} ) + {h}_{x} C ( {c}_{13} + {c}_{55} ) + {h}_{y} C ( {c}_{63} + {c}_{54} ) + {Cc}_{53} ] = - {h}_{x} ( {c}_{11} \frac{\partial {v}_{x}}{\partial ξ} + {c}_{12} \frac{\partial {v}_{y}}{\partial κ} + {c}_{14} \frac{\partial {v}_{z}}{\partial κ} + {c}_{15} \frac{\partial {v}_{z}}{\partial ξ} + {c}_{16} ( \frac{\partial {v}_{x}}{\partial κ} + \frac{\partial {v}_{y}}{\partial ξ} ) ) - {h}_{y} ( {c}_{61} \frac{\partial {v}_{x}}{\partial ξ} + {c}_{62} \frac{\partial {v}_{y}}{\partial κ} + {c}_{64} \frac{\partial {v}_{z}}{\partial κ} + {c}_{65} \frac{\partial {v}_{z}}{\partial ξ} + {c}_{66} ( \frac{\partial {v}_{x}}{\partial κ} + \frac{\partial {v}_{y}}{\partial ξ} ) ) - {c}_{51} \frac{\partial {v}_{x}}{\partial ξ} - {c}_{52} \frac{\partial {v}_{y}}{\partial κ} - {c}_{54} \frac{\partial {v}_{z}}{\partial κ} - {c}_{55} \frac{\partial {v}_{z}}{\partial ξ} - {c}_{56} ( \frac{\partial {v}_{x}}{\partial κ} + \frac{\partial {v}_{y}}{\partial ξ} ) , & ( 20 ) \\ \frac{\partial {v}_{x}}{\partial η} [ {h}_{x}^{2} {Cc}_{61} + {h}_{y}^{2} {Cc}_{26} + {h}_{x} {h}_{y} C ( {c}_{21} + {c}_{66} ) + {h}_{x} C ( {c}_{41} + {c}_{65} ) + {h}_{y} C ( {c}_{25} + {c}_{46} ) + {Cc}_{45} ] + \frac{\partial {v}_{y}}{\partial η} [ {h}_{x}^{2} {Cc}_{66} + {h}_{y}^{2} {Cc}_{22} + {h}_{x} {h}_{y} C ( {c}_{26} + {c}_{62} ) + {h}_{x} C ( {c}_{46} + {c}_{64} ) + {h}_{y} C ( {c}_{24} + {c}_{42} ) + {Cc}_{44} ] + \frac{\partial {v}_{z}}{\partial η} [ {h}_{x}^{2} {Cc}_{65} + {h}_{y}^{2} {Cc}_{24} + {h}_{x} {h}_{y} C ( {c}_{25} + {c}_{64} ) + {h}_{x} C ( {c}_{45} + {c}_{63} ) + {h}_{y} C ( {c}_{23} + {c}_{44} ) + {Cc}_{43} ] = - {h}_{x} ( {c}_{61} \frac{\partial {v}_{x}}{\partial ξ} + {c}_{62} \frac{\partial {v}_{y}}{\partial κ} + {c}_{64} \frac{\partial {v}_{z}}{\partial κ} + {c}_{65} \frac{\partial {v}_{z}}{\partial ξ} + {c}_{66} ( \frac{\partial {v}_{x}}{\partial κ} + \frac{\partial {v}_{y}}{\partial ξ} ) ) - {h}_{y} ( {c}_{21} \frac{\partial {v}_{x}}{\partial ξ} + {c}_{22} \frac{\partial {v}_{y}}{\partial κ} + {c}_{24} \frac{\partial {v}_{z}}{\partial κ} + {c}_{25} \frac{\partial {v}_{z}}{\partial ξ} + {c}_{26} ( \frac{\partial {v}_{x}}{\partial κ} + \frac{\partial {v}_{y}}{\partial ξ} ) ) - {c}_{41} \frac{\partial {v}_{x}}{\partial ξ} - {c}_{42} \frac{\partial {v}_{y}}{\partial κ} - {c}_{44} \frac{\partial {v}_{z}}{\partial κ} - {c}_{45} \frac{\partial {v}_{z}}{\partial ξ} - {c}_{46} ( \frac{\partial {v}_{x}}{\partial κ} + \frac{\partial {v}_{y}}{\partial ξ} ) , \\ and & ( 21 ) \\ \frac{\partial {v}_{x}}{\partial η} [ {h}_{x}^{2} {Cc}_{51} + {h}_{y}^{2} {Cc}_{46} + {h}_{x} {h}_{y} C ( {c}_{41} + {c}_{56} ) + {h}_{x} C ( {c}_{31} + {c}_{55} ) + {h}_{y} C ( {c}_{36} + {c}_{45} ) + {Cc}_{35} ] + \frac{\partial {v}_{y}}{\partial η} [ {h}_{x}^{2} {Cc}_{56} + {h}_{y}^{2} {Cc}_{42} + {h}_{x} {h}_{y} C ( {c}_{52} + {c}_{46} ) + {h}_{x} C ( {c}_{54} + {c}_{36} ) + {h}_{y} C ( {c}_{32} + {c}_{44} ) + {Cc}_{34} ] + \frac{\partial {v}_{z}}{\partial η} [ {h}_{x}^{2} {Cc}_{55} + {h}_{y}^{2} {Cc}_{44} + {h}_{x} {h}_{y} C ( {c}_{45} + {c}_{54} ) + {h}_{x} C ( {c}_{35} + {c}_{53} ) + {h}_{y} C ( {c}_{34} + {c}_{43} ) + {Cc}_{33} ] = - {h}_{x} ( {c}_{51} \frac{\partial {v}_{x}}{\partial ξ} + {c}_{52} \frac{\partial {v}_{y}}{\partial κ} + {c}_{54} \frac{\partial {v}_{z}}{\partial κ} + {c}_{55} \frac{\partial {v}_{z}}{\partial ξ} + {c}_{56} ( \frac{\partial {v}_{x}}{\partial κ} + \frac{\partial {v}_{y}}{\partial ξ} ) ) - {h}_{y} ( {c}_{41} \frac{\partial {v}_{x}}{\partial ξ} + {c}_{42} \frac{\partial {v}_{y}}{\partial κ} + {c}_{44} \frac{\partial {v}_{z}}{\partial κ} + {c}_{45} \frac{\partial {v}_{z}}{\partial ξ} + {c}_{46} ( \frac{\partial {v}_{x}}{\partial κ} + \frac{\partial {v}_{y}}{\partial ξ} ) ) - {c}_{31} \frac{\partial {v}_{x}}{\partial ξ} - {c}_{32} \frac{\partial {v}_{y}}{\partial κ} - {c}_{34} \frac{\partial {v}_{z}}{\partial κ} - {c}_{35} \frac{\partial {v}_{z}}{\partial ξ} - {c}_{36} ( \frac{\partial {v}_{x}}{\partial κ} + \frac{\partial {v}_{y}}{\partial ξ} ) , & ( 22 )\end{matrix}$$

where the A's and B's have been replaced by Chₓ and Ch_{y} respectively, from relations (18) valid at the free-surface. Equations (20)-(22) are boundary conditions in terms of particle velocities for free-surface topography on top of tilted orthorhombic or simpler anisotropic elastic media.

For a plane, horizontal free-surface, the curved grid reduces to a rectangular grid, so we can set C≡1, and the slopes hₓ and h_{y} vanish. Then the boundary conditions reduce to

$$\begin{matrix}\frac{\partial {v}_{x}}{\partial η} {c}_{55} + \frac{\partial {v}_{y}}{\partial η} {c}_{54} + \frac{\partial {v}_{z}}{\partial η} {c}_{53} = - {c}_{51} \frac{\partial {v}_{x}}{\partial ξ} - {c}_{52} \frac{\partial {v}_{y}}{\partial κ} - {c}_{54} \frac{\partial {v}_{z}}{\partial κ} - {c}_{55} \frac{\partial {v}_{z}}{\partial ξ} - {c}_{56} ( \frac{\partial {v}_{x}}{\partial κ} + \frac{\partial {v}_{y}}{\partial ξ} ) , & ( 23 ) \\ \frac{\partial {v}_{x}}{\partial η} {c}_{45} + \frac{\partial {v}_{y}}{\partial η} {c}_{44} + \frac{\partial {v}_{z}}{\partial η} {c}_{43} = - {c}_{41} \frac{\partial {v}_{x}}{\partial ξ} - {c}_{42} \frac{\partial {v}_{y}}{\partial κ} - {c}_{44} \frac{\partial {v}_{z}}{\partial κ} - {c}_{45} \frac{\partial {v}_{z}}{\partial ξ} - {c}_{46} ( \frac{\partial {v}_{x}}{\partial κ} + \frac{\partial {v}_{y}}{\partial ξ} ) , \\ and & ( 24 ) \\ \frac{\partial {v}_{x}}{\partial η} {c}_{35} + \frac{\partial {v}_{y}}{\partial η} {c}_{34} + \frac{\partial {v}_{z}}{\partial η} {c}_{33} = - {c}_{31} \frac{\partial {v}_{x}}{\partial ξ} - {c}_{32} \frac{\partial {v}_{y}}{\partial κ} - {c}_{34} \frac{\partial {v}_{z}}{\partial κ} - {c}_{35} \frac{\partial {v}_{z}}{\partial ξ} - {c}_{36} ( \frac{\partial {v}_{x}}{\partial κ} + \frac{\partial {v}_{y}}{\partial ξ} ) . & ( 25 )\end{matrix}$$

A regular standard grid or a staggered grid may also be used. However, regular standard grids are preferable to staggered grids, since often regular staggered grids do not naturally adapt to correct physical locations when describing anisotropic wave equations and topography boundary conditions. Standard grid discretization tends to be less stable in application. Therefore, Fully Staggered Grids (FSG; Puente et al., 2014) is preferable to ensure accuracy and stability in complex media in spite of increased memory and computational requirement associated with FSG.

The time derivatives of equations (4) were solved for the stresses and equations (15)-(17) for the velocities. These nine field variables become 36 (a factor 4) due to the use of FSG. The same factor theoretically applies to the increase of computational cost, however due to loop parallelization (using open MP) this factor is closer to 3 in practice. The wave equations (4) and (15)-(17) are solved as first-order partial differential equations (PDEs) for propagation in an elastic tilted orthorhombic medium. They are discretized by eight-order staggered FDs (Fornberg, 1988) in space and second-order staggered FDs in time. Nine full grids of material parameters (the nine stiffness parameters) are required for elastic vertical orthorhombic modeling, and the 21 stiffnesses required for tilted orthorhombic modeling can be calculated on the fly from these to save memory. Then in addition the three rotation angles for dip, azimuth and β need to be stored in full 3D grids.

In an embodiment of the current disclosure, the method involves storing all 21 stiffnesses but reducing the number of other computations. On the basis of definitions given in Tsvankin (1987), relationships can be calculated for transition from material input parameters ε's, δ's and γ's mentioned in FIG. 1, to the material stiffness matrix C—which again determines the (an)isotropic speeds Vp and Vs and density ρ.

Boundary conditions (20)-(22) (alternatively in their form of a free plane-surface, equations (23)-(25)), are implemented at the free-surface. Full (8th) FD-order can be maintained in the implementation of these free-surface boundary conditions by assuming the local particle velocities to be constant above the free-surface in a layer of nodal depth of the FD-operator's half order (4 in examples in this disclosure; Jastram and Behle, 1993). Experience shows no qualitative degeneration of results by assuming such constant fields above the free-surface, when compared to the alternative, which is gradual reduction of FD-order from interior medium (8^{th} order FDs) towards minimum 2^{nd} order FDs at the free-surface. In this process, one would go via 6^{th} and 4^{th} order central FDs. For the stresses, mirror conditions around the free-surface are imposed on the normal traction, implying that its surface value is zero.

For absorbing boundary conditions along all boundaries (except the top, in free-surface cases), the sponge/exponential damping method (Cerjan et al., 1985) was used, for which the damping coefficient for optimal absorption has to be found empirically for the relevant wave propagation scheme.

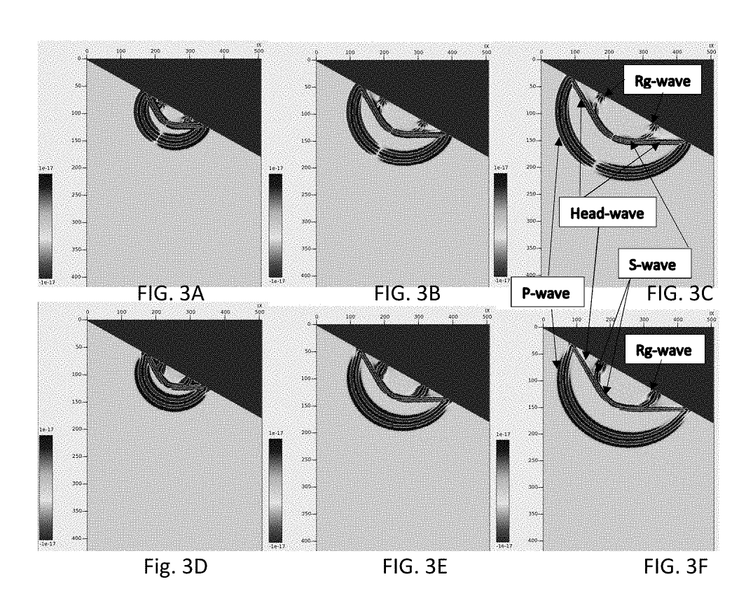

FIGS. 3A-3F show a same homogeneous elastic isotropic medium covered by a tilted, plane free-surface. The tilt in this case is negative 30°. Vp=3500 m/s. Vs=1750 m/s. The density is 2084.5 kg/m³. A Ricker explosion source of peak frequency 15 Hz is released at the middle of the tilted free-surface. Dimensions in x- and y-directions are 4000 m and model depth (in rectangular grid) is 6000 m. The grid lengths are 10 m uniformly. Twenty (20) absorbing layers are added to each grid edge except at the free-surface. The top three panels (FIGS. 3A-3C) are snapshots in the xz-plane whiles the bottom three panels (FIGS. 3D-3F) are snapshots in the yz-plane. Components shown are tangential (top) and normal (bottom) particle velocities to the free-surface. The P-, S-, and head waves connecting them from the surface, as well as the Rg-waves at the surface are observed and are labeled in the two snapshots on the right. Note that the Rg-waves are slightly slower than the S-wave front.

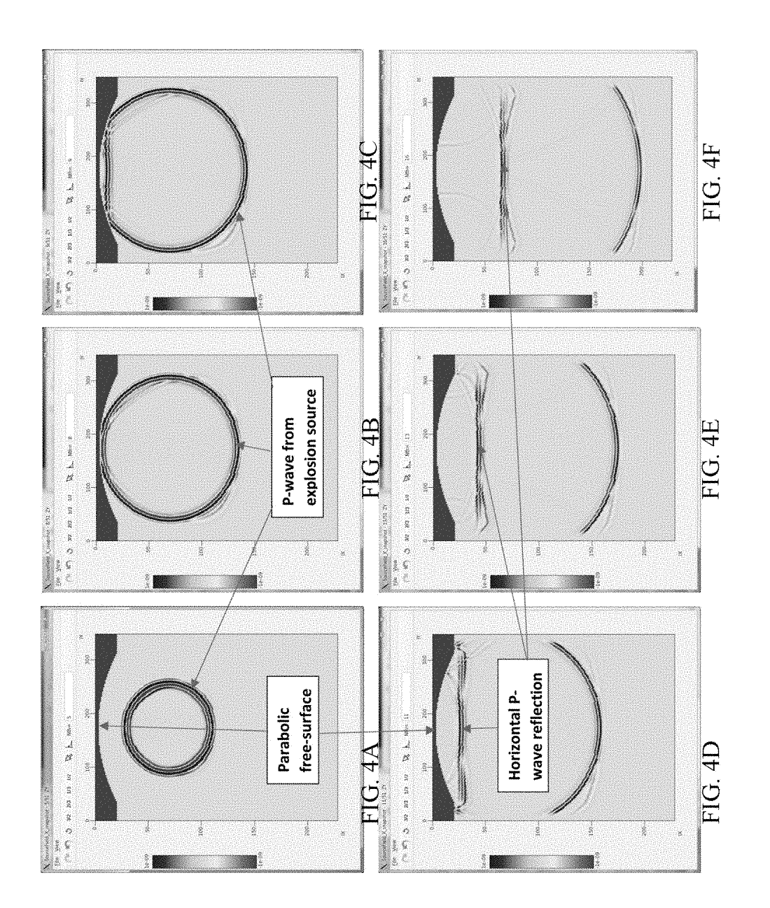

FIGS. 4A-4F are pressure snapshots along a vertical plane of a Ricker point source released at the focus of a parabolic free-surface, and the resulting plane wave reflected back from it into the medium. The model has homogeneous P- and S-velocities of 4500 and 2600 m/s, and the grid distance is 20 m in the horizontal directions and 40 m in the vertical direction. The result of the simulation is consistent with a known effect in the particular case of a free-surface parabola covering a homogeneous, isotropic medium. That is, the reflection of a point source released at the focus of the parabola from the free-surface back into the medium is expected to be a plane wave, which is approximately true for the reflected pressure (P-) wave.

In FIGS. 4A-4F, the parabola is a free-surface topography over a homogeneous, isotropic medium. The pressure (P-) wave reflected from the free-surface back into the medium is approximately a plane wave, as expected. The deviation from the circle around the P-wave in the three panels (FIGS. 4A-4C) in the top row are numerical grid artifacts from the curved grid. The artifacts in three panels (FIGS. 4D-4F) in the bottom row along the parabola free-surface after the plane P-wave reflection back from it are the physical phenomena of the slower S/Rg (Rayleigh) wave train propagating along the surface following the horizontal plane P-wave. There is a wave proceeding the plane P-wave reflection, appear like a “hook” on either side of the plane P-wave are due to grid artifacts from the compression of the grid nodes at either side (the steepest part) of the parabola.

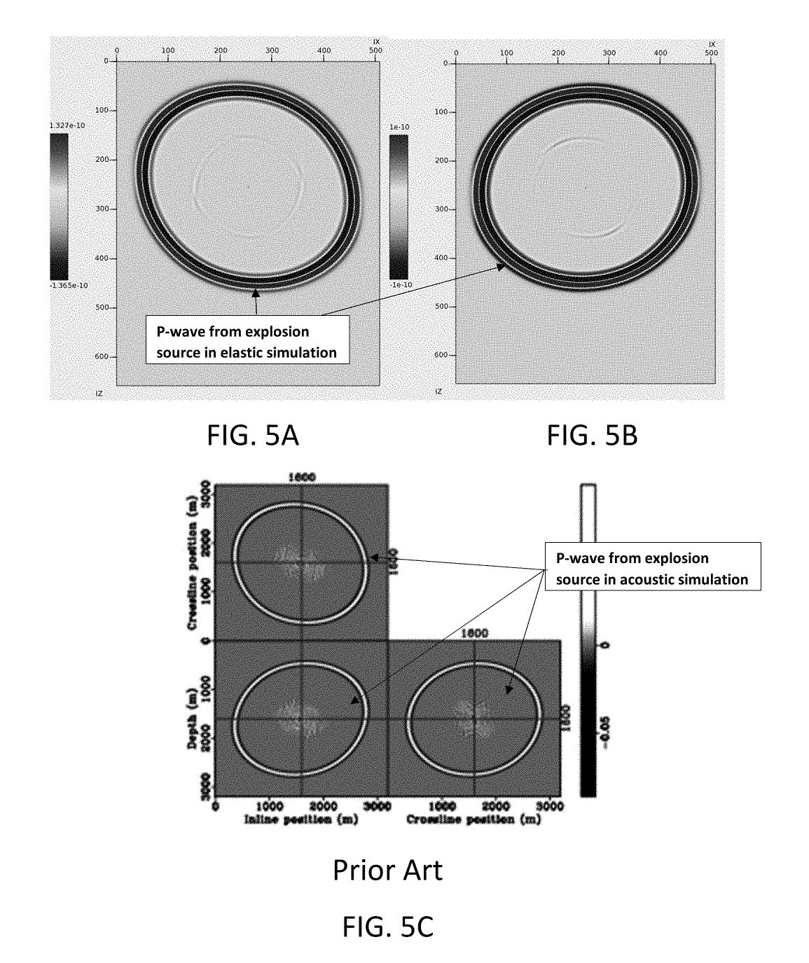

FIGS. 5A and 5B show a homogeneous acoustic tilted orthorhombic model covered by a plane horizontal free-surface, using acoustic parameters in the elastic code. The model has Vp=4500 m/s, Vs=2250 m/s, density=2200 kg/m³, ε₁=0.2, ε₂=0.12, δ₁=δ₂=0.06, δ₃=0, γ₁=γ₂=0, ϕ=35°, θ=40° and β=25°. The dimensions are 4000 m horizontally in both directions and 6000 in depth. Grid distances are 10 m uniformly, and a Ricker point source of peak frequency 15 Hz is excited at 2500 m depth. For comparison, the bottom panel FIG. 5C shows P-waves from explosion source in acoustic simulation from Chu (2012). As one can readily appreciate, the P-wave form resulting from a simulation according to this disclosure is consistent with those in Chu, further validating the applicability of this modeling method.

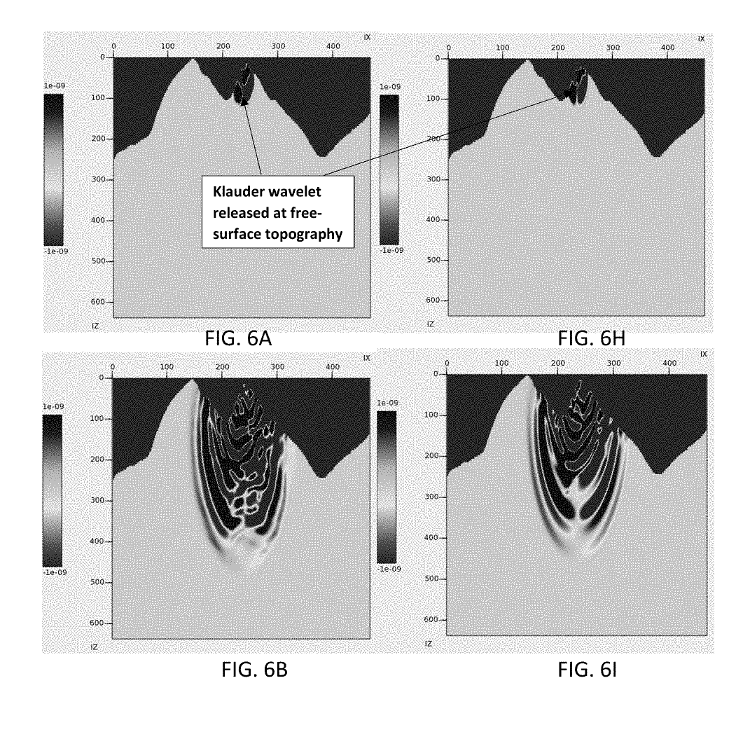

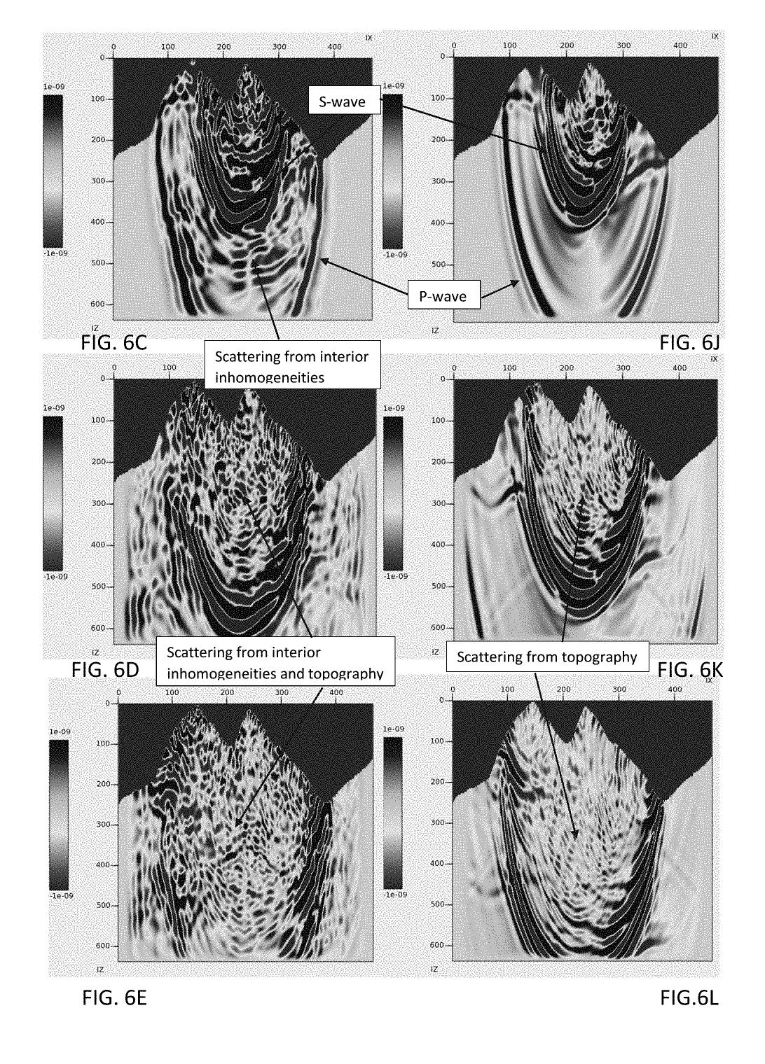

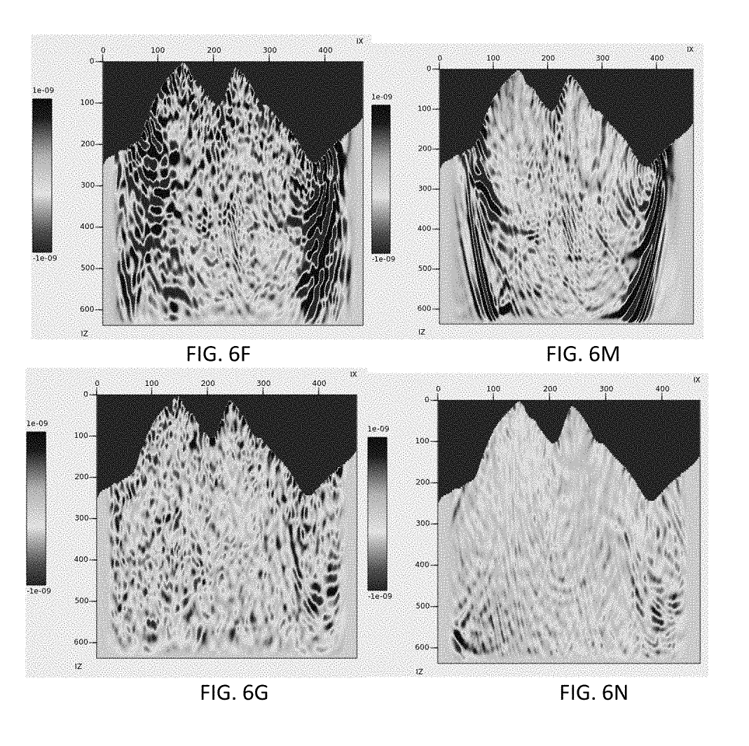

FIGS. 6A-6G are Vx particle velocity component snapshots along a vertical xz-plane through the SEAM (SEG Advance Modeling Program) heterogeneous, isotropic topography model while FIGS. 6H-6N from the same model but with homogeneous interior parameters Vp=3500 m/s, Vs=1750 m/s and density 2200 kg/m³. A vertical Klauder wavelet of central frequency 15 Hz is released at the same location of the free-surface of both models. The two cases are compared for the same free-surface topography. Common wave features can be confirmed. However, snapshots for the heterogeneous medium (panels on the left, FIGS. 6A-6G) exhibit more wavefield complexities, e.g., scattering from interior inhomogeneities.

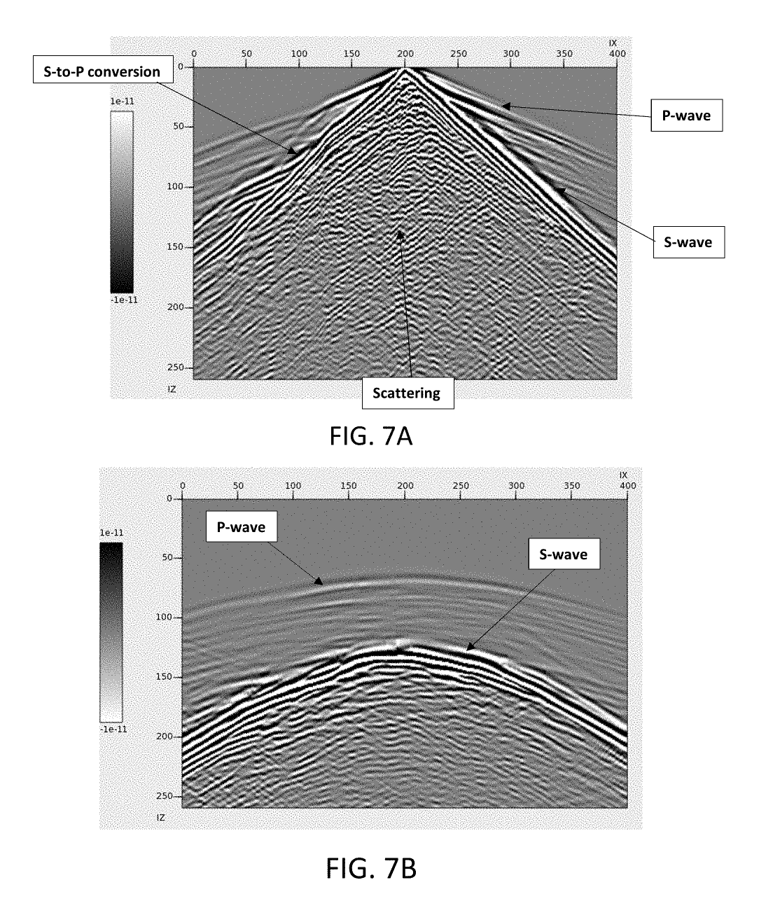

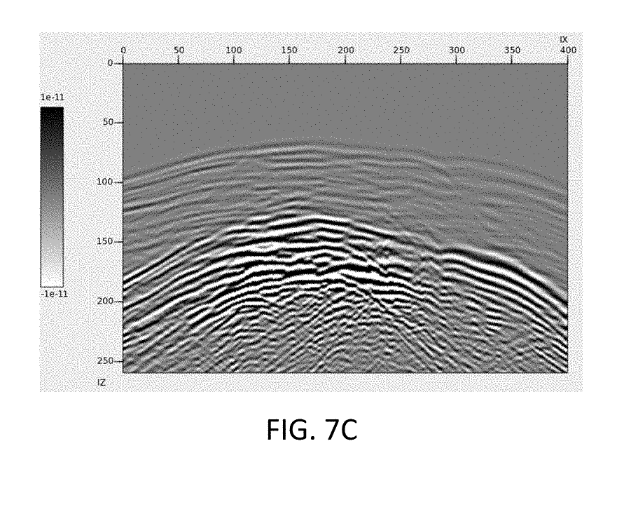

FIGS. 7A, 7B, and 7C respectively shows pressure seismograms from middle, left and right cross sections from the above SEAM topography (heterogeneous) example of FIGS. 6A-6N. P-wave, S-wave, as well as scattering are labeled.

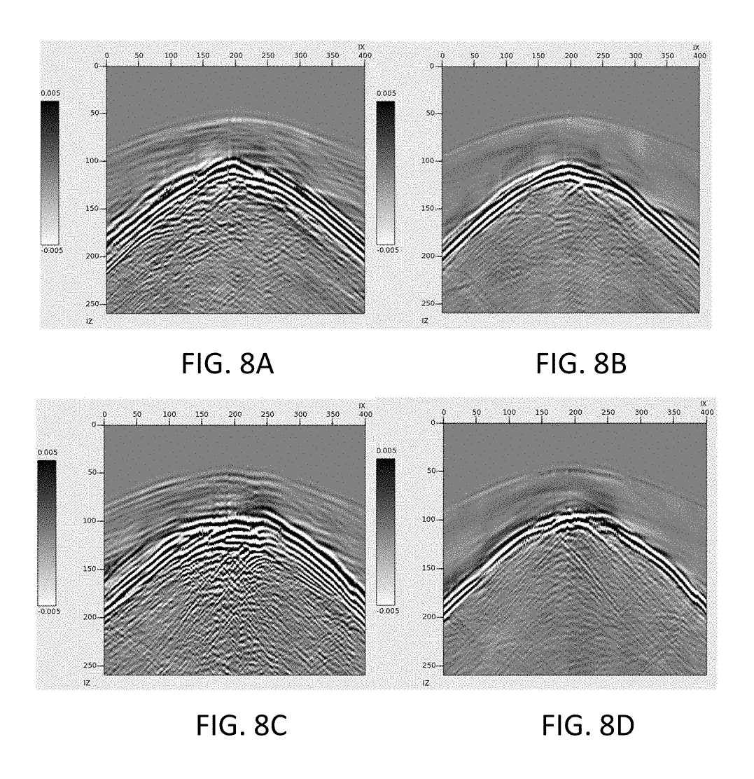

FIGS. 8A-8D are some representative corresponding seismic sections from the full heterogeneous isotropic SEAM topography model (FIGS. 8A and 8C) and the homogeneous model (FIGS. 8B and 8D) of the simulations of FIGS. 6A-6N. Both exhibit similar waveforms. However, the heterogeneous isotropic SEAM topography model provides far more details in the heterogeneities add far more wavefield complexity.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

### REFERENCES

Cerjan, C., Kosloff, D., Kosloff R., and Reshef, M. (1985) Short note on a nonreflecting boundary condition for discrete acoustic-wave and elastic-wave equations, Geophysics, 50, pp. 705-708.
Fornberg, B. (1988) Generation of Finite Difference Formulas on Arbitrarily Spaced Grids, Mathematics of Computation, 51, no. 184, pp. 699-706.
Hestholm, S., and Ruud, B. (1998) 3-D finite-difference elastic wave modeling including surface topography, Geophysics, 63 no. 2, pp. 613-622.
S. Hestholm (2002) Composite Memory Variable Velocity-Stress Viscoelastic Modelling, Geophys. J. Int., 148, pp. 153-162.
S. Hestholm and B. Ruud (2002) 3-D Free-Boundary Conditions for Coordinate-Transform Finite-Difference Seismic Modelling, Geophys. Prosp., 50, pp. 463-474.
Jastram, C., and Behle, A. (1993) Elastic Modeling by Finite-Difference and the Rapid Expansion Method (REM), Expanded abstract, ST3.6, Soc. Of Exploration Geophysics, pp. 1573-1576.
de la Puente, J., Ferrer, M., Hanzich, M., Castillo, J. E., and Cela, J. M. (2014) Mimetic seismic wave modeling including topography on deformed staggered grids, Geophysics, 79, no. 3, pp. T125-T141.
Tessmer, E., and Kosloff, D. (1994) 3-D elastic modeling with surface topography by a Chebychev spectral method, Geophysics, 59, no. 3, pp. 464-473.
Tsvankin, I. (1997) Anisotropic parameters and P-wave velocity for orthorhombic media, Geophysics, 62, no. 4, pp. 1292-1309.

What is claimed is:

1. A method for simulating seismic waves, comprising:
reading a plurality of parameters of a grid and a plurality of seismic acquisition data into a model;
reading a plurality of parameter of a medium of a earth formation into the model;
applying a free-surface boundary condition to the model, wherein the free-surface boundary conditions are applied in a curved grid;
converting the free-surface boundary condition in the curved grid to a rectangular computational grid;
constructing a Hooke's law equation (4) in the rectangular computational grid;
constructing momentum conservation equations (15)-(17) in the rectangular computational grid;
solving the Hooke's law equation and the momentum conservation equations in the rectangular computation grid by applying the free-surface boundary conditions; and
obtaining a resulting data, wherein the output data are seismograms or snapshots of seismic pressure, or stress components, or particle velocities of the seismic wave.

2. The method of claim 1, wherein the curved grid has a planar bottom and a curvilinear top that coincides with the free-surface topology.

3. The method of claim 1, wherein the free-surface boundary condition is vanishing normal traction at any point on a surface of the curved grid.

4. The method of claim 1, wherein the medium of the earth formation is an elastic medium of anisotropy of tilted orthorhombic symmetry.

5. The method of claim 1, wherein a numerical discretization method is employed in solving the Hooke's law equation and the momentum conservation equations in the rectangular computation grid.

6. The method of claim 5, where in the numerical discretization method is a finite-difference (FD) method, a finite element (FE) method, a spectral element (SE) method.

7. The method of claim 1, further comprising inputting the resulting data into a seismic imaging method, a full waveform inversion (FWI) method, an elastic reverse time migration method.
